(19) United States
(12) Patent Application Publication
(10) Pub. No.: US 2020/0103263 A1
(43) Pub. Date: Apr. 2, 2020

(54) MEASURING DEVICE AND METHOD FOR DETERMINING A FLUID VARIABLE

(71) Applicant: DIEHL METERING GMBH, Ansbach (DE)

(72) Inventors: PETER PLOSS, BAYREUTH (DE); MICHAEL MAYLE, ANSBACH (DE)

(21) Appl. No.: 16/700,208

(22) Filed: Dec. 2, 2019

Related U.S. Application Data
(63) Continuation of application No. PCT/EP2018/000303, filed on Jun. 11, 2018.

(30) Foreign Application Priority Data
Jun. 29, 2017 (DE) 102017006173

(51) Int. Cl. G01F 1/66

(52) U.S. Cl. CPC G01F 1/667; G01F 1/662

(57) ABSTRACT

A measuring device for determining a fluid variable has a control device, a measuring tube, and first and second ultrasound transducers on the measuring tube. The ultrasound transducer(s) are driven to excite a wave through a side wall of the measuring tube and to excite compression oscillations of the fluid. The other ultrasound transducer records the oscillations to determine measurement data, and the fluid variable is determined based on the measurement data. Either the first and/or the second ultrasound transducer has an oscillation element coupled in a plurality of separated contact regions of the oscillation element to the measuring tube or to a carrier structure (19, 32, or the first and/or the second ultrasound transducer respectively have a plurality of oscillation elements coupled in separate contact regions of the measuring tube, or of a carrier structure coupled to the measuring tube, to the measuring tube or the carrier structure.

### CROSS-REFERENCE TO RELATED APPLICATION

This application is a continuation, under 35 U.S.C. § 120, of copending international application No. PCT/EP2018/000303, filed Jun. 11, 2018, which designated the United States; this application also claims the priority, under 35 U.S.C. § 119, of German patent application DE 10 2017 006 173, filed Jun. 29, 2017; the prior applications are herewith incorporated by reference in their entirety.

### BACKGROUND OF THE INVENTION

### Field of the Invention

The invention relates to a measuring device for determining a fluid variable relating to a fluid and/or a fluid flow of the fluid with a control device, a measuring tube which receives the fluid and/or through which the fluid can flow, and a first and a second ultrasound transducer which are arranged at a distance from one another on the measuring tube, wherein the first and/or the second ultrasound transducer can be driven by the control device in order to excite a wave which is conducted through a side wall of the measuring tube, wherein the conducted wave excites compression oscillations of the fluid, which oscillations can be conducted via the fluid to the respective other ultrasound transducer and can be recorded there by the control device in order to determine measurement data, wherein the fluid variable can be determined by the control device as a function of the measurement data. The invention furthermore relates to a method for determining a fluid variable.

One possibility for measuring a flow through a measuring tube involves ultrasonic meters. In these, at least one ultrasound transducer is used in order to couple an ultrasound wave into the fluid flowing through the measuring tube, this wave being conducted on a straight path or after multiple reflections at walls or special reflector elements to a second ultrasound transducer. A flow rate through the measuring tube can be determined from the time of flight of the ultrasound wave between the ultrasound transducers, or from a time-of-flight difference in the event of interchanging of the transmitter and receiver.

In order to simplify the measuring structure, U.S. Pat. No. 4,735,097 proposes to use ultrasound transducers which are fastened externally on the measuring tube. These are used in order to induce conducted waves in the measuring tube, whereby a lower accuracy is required in the arrangement of the ultrasound transducers on the measuring tube. In order to couple the conducted waves in, a wedge-shaped element is used, the longest side of which is pressed onto the tube wall and on the shortest side of which a piezo element is arranged. The latter is set in oscillations in order to induce a conducted wave in the tube wall via the wedge-shaped element. A disadvantage in this case is that the measuring structure used is relatively complex and large. It therefore cannot be used, or can be used only with great outlay, in many measuring situations in which a flow measurement is desired. In addition, due to the use of the additional wedge-shaped element, only a low efficiency of the coupling-in of oscillations is achieved, as a result of which the exciting piezo element has to be dimensioned so as to be relatively large.

It is known from the article G. Lindner, “Sensors and actuators based on surface acoustic waves propagating along solid-liquid interfaces”, J. Phys. D: Appl. Phys. 41 (2008) 123002, in order to excite conducted waves, to use so-called interdigital transducers in which a piezoelectric element is used which comprises control lines engaging in one another in a comb-like fashion, in order to achieve excitation of particular excitation modes of conducted waves. Since shear modes of the piezoelectric element are necessarily excited, high efficiencies of the excitation are typically not achieved. Furthermore, relatively elaborate, high-accuracy lithography is required in order to apply the required electrode structure with sufficient accuracy, sufficient mode purity of the excitation nevertheless often not being achieved.

Excitation of a pure-mode conducted wave is, however, highly relevant for use in an ultrasonic meter, since the angle at which compression oscillations are emitted into the fluid depends on the phase velocity of the conducted wave, which is typically different in different excitation modes for the same excited frequency. Therefore, if different modes are excited, different propagation paths for the compression oscillations in the fluid thus result, which can at best be compensated for by elaborate signal evaluation.

### SUMMARY OF THE INTENTION

It is accordingly an object of the invention to provide a fluid meter and method, which overcome the above-mentioned and other disadvantages of the heretofore-known devices and methods of this general type and which provides for a measuring device which uses conducted waves for the measurement, the intention being to achieve a small installation space requirement and a simple structure and preferably to achieve maximally pure-mode excitation of conducted waves.

With the above and other objects in view there is provided, in accordance with the invention, a measuring device for determining a fluid variable relating to a fluid and/or a fluid flow of the fluid, the measuring device comprising:

a control device;

a measuring tube for containing the fluid or the fluid flow;

first and second ultrasound transducers disposed on said measuring tube at a spacing distance from one another, with one or both of said ultrasound transducers being configured to be driven by said control device in order to excite a wave that is conducted through a side wall of said measuring tube, wherein the conducted wave excites compression oscillations of the fluid that are conducted via the fluid to the respectively other ultrasound transducer and are recorded there by the control device in order to determine measurement data, and wherein the fluid variable is determined by said control device in dependence on the measurement data;

wherein either said first ultrasound transducer and/or said second ultrasound transducer respectively includes an oscillation element coupled in a plurality of mutually separated contact regions of said oscillation element to said measuring tube or to a carrier structure disposed between said measuring tube and said oscillation element; or

wherein said first ultrasound transducer and/or said second ultrasound transducer respectively include a plurality of oscillation elements coupled in mutually separated contact regions of said measuring tube, or of a carrier structure coupled to said measuring tube, to said measuring tube, or said carrier structure.

In other words, the object is achieved according to the invention by a measuring device of the type mentioned in the introduction, wherein

either the first and/or the second ultrasound transducer respectively comprise an oscillation element which is coupled, in particular only, in a plurality of mutually separated contact regions of the oscillation element to the measuring tube or to a carrier structure arranged between the measuring tube and the oscillation element,

or wherein the first and/or the second ultrasound transducer respectively comprise a plurality of oscillation elements which are coupled, in particular only, in mutually separated contact regions of the measuring tube, or of a carrier structure connected to the measuring tube, to the measuring tube or the carrier structure.

According to the invention, it is proposed to couple an oscillation element directly or indirectly to the measuring tube only in mutually separated contact regions, or to use a plurality of oscillation elements, in order to excite the tube or the carrier structure in a plurality of mutually separated contact regions. In both cases, locally inhomogeneous excitation of the measuring tube or of that side wall which is intended to conduct the conducted wave results. Such inhomogeneous excitation may be used in order to deliberately excite particular oscillation modes of the side wall or of the measuring tube, in particular oscillation modes of Lamb or Rayleigh waves, with high mode purity. This may be achieved by the excitation pattern used being tuned to a wavelength of a conducted wave to be excited.

Since pure-mode excitation is carried out by selection of a corresponding arrangement of the contact regions, the wavelength of the oscillation of the oscillation element is not relevant, or only of little relevance, for the achievable mode purity. For excitation of a conducted wave with a high mode purity, it is therefore necessary only to tune the excitation frequency to the wavelength of the conducted wave to be generated, or the arrangement of the contact regions. It is therefore possible to select a form of oscillation of the oscillation element, or of the oscillation elements, which allows best possible coupling of the oscillation energy into the side wall. Preferably, a contraction or expansion oscillation perpendicular to the side wall is used. This may, for example, be achieved by the oscillation element, or each oscillation element, comprising two opposite electrodes, one of the electrodes being arranged on a side of the respective oscillation element next to the measuring tube and the other on an opposite side. However, a first electrode may also be arranged on a first side surface and a second electrode may be arranged predominantly on the opposite side surface but engage around the oscillation element and bear with a relatively short contact section on the first side surface. This may allow simple contacting of an electrode which is arranged primarily on a side of the oscillation element facing toward the measuring tube. The oscillation element, or all the oscillation elements, may in particular be formed from piezoceramic and comprise at least two electrodes, which are preferably arranged as explained above. In particular, the oscillation element or each oscillation element may be cuboid in shape and comprise two side surfaces which extend parallel to the side wall, or at least the outer surface of the side wall.

Measurements may be carried out on a fluid flow flowing through the measuring tube, but also on a fluid which is stationary in the measuring tube. The measuring device may also comprise more than two oscillation transducers. For example, oscillation emitted by a first oscillation transducer may be recorded by a plurality of second oscillation transducers in order, for example, to take different propagation paths into account or to validate measurement data.

The use of oscillation transport in order to record fluid properties is known in principle in the prior art. In ultrasonic meters, for example, time-of-flight differences of a time of flight of an oscillation between a first and a second ultrasound transducer, and vice versa, are often recorded and a flow rate can be determined therefrom. It is, however, also possible to evaluate other measurement data in order to determine fluid properties. For example, a signal amplitude at the receiving oscillation transducer may be evaluated in order to record attenuation of the oscillation during transport through the fluid. Amplitudes may also be evaluated frequency-dependently, and absolute or relative amplitudes of particular spectral ranges may be evaluated in order to record a spectrally different attenuation behavior in the fluid. Phase angles of different frequency bands may also be evaluated, in order for example to obtain information about the dispersion relation in the fluid. As an alternative or in addition, changes in the spectral composition or the amplitude as a function of time, for example within a measurement pulse, may also be evaluated.

By evaluation of these quantities, a flow rate and/or a flow volume and/or a density, temperature and/or viscosity of the fluid may for example be determined as fluid variables. In addition or as an alternative, for example, a speed of sound in the fluid and/or a composition of the fluid, for example a mixing ratio of different components, may be determined. Various approaches for obtaining these fluid variables from the measurement quantities explained above are known in the prior art, and shall therefore not be presented in detail. For example, relationships between one or more measurement quantities and the fluid variable may be determined empirically, and for example a look-up table or a corresponding formula may be used in order to determine the fluid variable.

The coupling of the oscillation element to the measuring tube may be carried out directly or indirectly. Preferably, the coupling is carried out via the carrier structure and/or via at least one viscous intermediate layer. The carrier structure may likewise be coupled directly or indirectly to the measuring tube or the oscillation element, preferably via a viscous intermediate layer. The oscillation element may, for example, be a piezoelectric oscillation element, an electromagnetic sound transducer, a capacitive micromechanical ultrasound transducer or an electroactive polymer.

The carrier structure may be formed separately from the measuring tube. An acoustic impedance of the carrier structure may be selected in such a way that it lies between the acoustic impedance of the oscillation element and the acoustic impedance of the side wall, whereby reflections at the interfaces can be reduced and more efficient coupling-in of oscillations can be achieved.

The carrier structure may for example be produced by milling, laser cutting, stamping, injection molding or the like. The carrier structure may, for example, be formed from plastic.

The carrier structure may be formed from a filled plastic. In these, particles, for example metal particles, are embedded in a plastic matrix. By selection of the particles and/or the particle concentration, the acoustic impedance of the carrier structure may be adapted.

If the oscillation element is intended, or the oscillation elements are intended, to be coupled directly or via a viscous intermediate layer without a separate carrier structure to the measuring tube, it is possible to shape the surface of the side wall facing toward the oscillation element, or the respective oscillation element, in such a way that the oscillation element or the oscillation elements is or are coupled to the measuring tube only in the contact regions. For example, projections or recesses on the side wall may be provided therefor.

If a plurality of oscillation elements are used, they are preferably driven together. For example, the same drive signal may be delivered by the control device to the electrodes of the various oscillation elements. The oscillation elements may be connected in parallel, or all their electrodes next to the measuring tube may be conductively connected and/or all their electrodes facing away from the measuring tube may be conductively connected. Preferably, the oscillation elements carry out the same oscillation movement together.

The distance between the centers of at least two contact regions of the first and/or of the second ultrasound transducer in the propagation direction of the conducted wave may correspond to an integer multiple of the wavelength of the conducted wave. For example, the distance may be equal to the wavelength, twice as great as the wavelength, etc. If a conducted wave with a wavelength of 1.8 mm is excited, for example, the centers of the contact regions may be separated from one another by 1.8 mm, 3.6 mm, 5.4 mm, etc.

The wavelength of the conducted wave may be rigidly predetermined by the properties of the measuring device. For example, the control device may drive the oscillation element, or the oscillation elements, in such a way that they oscillate with a defined frequency, in which case the frequency of the conducted wave may correspond to the frequency of the oscillation of the oscillation elements. If the measuring device is configured with a design such that substantially pure-mode excitation takes place at one frequency, excitation with a defined wavelength is also carried out. In principle, it would also be possible to vary the excitation frequency as a function of particular parameters, for example a measured temperature, in order to compensate for a temperature dependency for example of the resonant frequency of the oscillation element or of the oscillation elements, and/or a mode structure of the excited side wall.

The propagation direction may be the same over the entire width of the side wall, or of the oscillation element or elements. This may, for example, be the case if the contact regions are formed by parallel rectangular surfaces. It is, however, also possible for the emission direction to vary locally. For example, curved contact regions may be used, the various excitation or contact regions preferably being parallel to one another. In this case, the propagation direction may, for example, always be perpendicular to an edge of the contact regions.

If the distances of the centers of the contact regions are selected as explained above, and if the interconnection or the driving of the oscillation elements is carried out in such a way that they oscillate synchronously in phase, constructive interference takes place for conducted waves whose wavelength corresponds to this distance or an integer divisor of this distance, i.e. in particular for the Lamb wave to be excited. The separated contact regions therefore act as a kind of wavelength-based bandpass filter for the excited conducted waves. If excitation is carried out with a frequency at which various oscillation modes of the side wall have sufficiently large wavelength differences, mode-selective excitation may approximately be achieved.

In one refinement of the measuring device according to the invention, more than two contact regions may be used, the centers of which respectively have equal distances from one another. In this way, the mode purity of the excitation may be further improved. In order to avoid different modes being excited simultaneously, however, care should in this case be taken that preferably none of the distances of various centers of the contact region corresponds to an integer multiple of a wavelength of another oscillation mode of the side wall with the same frequency.

It is possible for a conducted wave to be excited with a frequency for which, according to the dispersion relation of the side wall, precisely two oscillation modes or at least two oscillation modes with different wavelengths exist, the wavelength of the second mode being two times as great as the wavelength of the first mode. If the distance of the centers of the contact regions is then selected in such a way that it is an odd integer multiple of the first wavelength, constructive interference results for the oscillation mode with the first wavelength. At the same time, destructive interference results for the oscillation mode with the second wavelength, since excitation with a distance of half the second wavelength is carried out for this, so that a phase shift of 180° and therefore cancellations result. By selection of such a working point, destructive interference may therefore deliberately be achieved for a second excitable mode, and therefore a higher mode purity. The frequency of the excited conducted wave may be predetermined by selection of the oscillation frequency of the oscillation element or of the oscillation elements. The control device may therefore be configured to drive the oscillation element, or the oscillation elements, in such a way that they oscillate with a defined frequency which corresponds to the working point described above.

The frequency of the conducted wave may be equal to a resonant frequency of the oscillation element or of the oscillation elements. Preferably, all the oscillation elements have the same resonant frequency. The resonant frequency of the oscillation element or of the oscillation elements may, for example, be adjusted in that, with given dimensions parallel to the side wall, a thickness of the oscillation element perpendicular to the side wall is selected in order to adjust a desired resonant frequency. Excitation of the oscillation element or of the oscillation elements at its or their resonant frequency leads to particularly efficient oscillation excitation at a defined oscillation frequency. The ultrasound transducer may therefore be adapted to excite a conducted surface wave with a defined frequency, and in particular a defined wavelength, with high efficiency.

Although mode selectivity of the excitation is achieved with the procedure described above, at the same time, however, propagation of the conducted wave at least in two opposite propagation directions necessarily results. In individual cases, this may lead to disruption of the measurement process, or a certain part of the excitation energy may be lost and not be used for the measurement. It may therefore be advantageous to configure the measuring device in such a way that propagation of the conducted wave takes place in an amplified way or only in one direction, or on one side in a particular solid angle range.

This may be made possible in that excitation of the measuring tube with a phase offset of 90° takes place by means of two contact regions of the first and/or of the second ultrasound transducer, the distance between the centers of the two contact regions in the propagation direction of the conducted wave being the sum of an integer multiple of the wavelength and one fourth of the wavelength of the conducted wave. For example, the distance may be 1.25 times, 2.25 times or 3.25 times the wavelength.

By means of the two contact regions, separate conducted waves, which are superposed, are respectively excited in the side wall. Because of the parameters described, the following conducted wave traveling in both directions is excited in the first of these regions:

$${y}_{1} = sin ( \frac{2 π}{λ} x - ω t ) + sin ( - \frac{2 π}{λ} x - ω t )$$

Here, λ is the wavelength, x is the distance from the excitation position, t is the time, and w is the product of 2π and the frequency of the conducted wave. Because of the phase offset and the distance between the regions, the following conducted wave traveling in both directions is excited in the second region:

$${y}_{2} = sin ( \frac{2 π}{λ} ( x + λ / 4 ) - ω t - π / 2 ) + sin ( - \frac{2 π}{λ} ( x + λ / 4 ) - ω t - π / 2 )$$

A superposition, i.e. a sum of the two waves, may be calculated by trigonometric rearrangement, the following result being obtained:

$${y}_{1} + {y}_{2} = 2 \cdot sin ( \frac{2 π}{λ} x - ω t )$$

A superposition of the two conducted waves therefore results in a conducted wave which propagates only in one propagation direction, since constructive interference results for this propagation direction and destructive interference results for the opposite propagation direction.

A phase offset for the excitation may be realized in that viscous layers, or carrier structures with different extents or made of different material, are used. For example, the extent of a carrier structure which is assigned to one of the contact regions may have a dimension perpendicular to the side wall such that the oscillation excited in this carrier structure takes an additional time, which corresponds to the inverse of the multiple of the frequency, in order to reach the side wall. As an alternative, it would also be possible to carry out the phase shift electronically. For example, the electrodes, next to the measuring tube and/or facing away from the measuring tube, of a plurality of oscillation elements could be coupled by means of a capacitor, or the like.

The first and/or the second ultrasound transducer may respectively comprise a plurality of piezoelectric oscillation elements, the oscillation elements being coupled to the measuring tube via a respective or a common carrier structure. The carrier structure, or the carrier structures, may contact the measuring tube only in the contact regions. The oscillation elements may be arranged separate from one another on a common carrier structure.

The carrier structure may comprise at least two mutually separated ribs, which are connected by connecting sections, the oscillation element or the oscillation elements bearing only on the ribs. The ribs may contact the oscillation element and/or the measuring tube only in the contact region. By forming the carrier structure from ribs and at least one connecting section, preferably a frame consisting of connecting sections, a defined arrangement of the ribs with respect to one another, and therefore also a defined arrangement of the contact regions with respect to one another, may be produced. In this way, the production of the measuring device may be simplified.

The ribs may form a comb-like structure on which the oscillation element bears, or which bears on the side surface. The ribs may, for example, have a rectangular or trapezoidal cross section. The trapezoid shape may be selected in such a way that the longer side of the trapezoid bears on the oscillation element, whereby more efficient oscillation coupling may be achieved under certain circumstances.

The ribs may extend perpendicularly to the propagation direction of the conducted wave. An individual rib may respectively be assigned to an individual contact region. The measuring device may be configured in such a way that the first and/or the second ultrasound transducer emit the conducted wave in a solid angle range, or that, with excitation of a certain width, focusing of the conducted wave takes place. In this case, the propagation direction is locally different at different points of the measuring device, particularly in the direction of the width of the side wall, i.e. perpendicularly to a direction in which the fluid flows through the measuring tube. The ribs may in this case respectively be perpendicular to the propagation direction along their extent in the individual regions, i.e. they may be curved.

The measuring tube may comprise, in the region of the first and/or of the second ultrasound transducer, a contact structure which comprises a plurality of projections and/or at least one recess, in which case the contact regions may be arranged only in the region of the projections and/or outside the region of the recess. By means of these recesses or projections, structures such as those described above in relation to the carrier structure may be formed, for example ribs which are separated from one another in the propagation direction and, in particular, extend perpendicularly to the propagation direction. By means of corresponding configuration of the side wall of the measuring tube, a separate carrier structure may therefore be obviated. In particular, the oscillation elements may be arranged on the measuring tube directly or via a viscous layer. In this case, a flat side surface of the oscillation element, or of the oscillation elements, may bear directly or via the viscous layer on the projections, or on the side wall outside the region of the recesses.

The contact regions may respectively have a constant length in the propagation direction of the conducted wave, and/or all the contact regions may have an equal predetermined width perpendicularly to the excitation direction. For example, the contact regions may be produced by ribs with the shapes described above, which bear on the side wall, or on the oscillation element, only in the corresponding regions.

It is possible for the contact regions to be curved. Starting from a midpoint, particularly in the direction of the width of the side wall, the side ends of the contact regions may lie in front or behind this midpoint in the propagation direction. A locally different propagation direction is therefore produced. This may be used in order to emit the conducted wave at a particular emission angle, or to focus it. In this case, the curvature may have a fixed radius of curvature, which may for example be greater than the width of the side wall of the measuring tube perpendicularly to a flow direction and/or less than ten times or one hundred times this width.

The oscillation element or the oscillation elements may be coupled via a viscous layer to the measuring tube or the respective carrier structure, and/or the carrier structure or the carrier structures may be coupled via a viscous layer to the measuring tube. This layer may have a viscosity of less than 10⁸ mPas (millipascal-seconds), in particular a viscosity of between 0.6 mPas and 10⁶ mPas. For example, a silicone oil, the properties of which may be further adapted by additives, for example introduced particles, may be used as a viscous coupling layer. The layer thickness of the coupling layer may be between 10 μm and 100 μm.

Compared to a rigid coupling, for example adhesive bonding, the advantage is achieved that stresses between the oscillation transducers and the measuring tube in the event of a temperature change are avoided. In many cases, the measuring tube, which is for example formed from metal or plastic, and the oscillation element, which may consist of a piezoceramic with applied electrodes, have different thermal expansion coefficients. Because of the viscous layer, these different expansions may be compensated for without stresses occurring and therefore, for example, the possibility that an adhesive layer may become brittle over time.

The viscous layer may be electrically conductive. In particular, an electrode, next to the measuring tube, of the oscillation element or of the oscillation elements may be contacted via the viscous layer. For example, the viscous layer may have a conductivity of more than 1 S/m (Siemens per meter), in particular of more than 10³ S/m. Preferably, even higher conductivities are achieved. The relatively low conductivities mentioned may, however, be sufficient since heavy currents do not need to be transported.

The viscous layer may contain metal particles. This may, on the one hand, be used in order to produce the conductivity mentioned above and, on the other hand, the viscosity of the layer may be adapted according to requirements by addition of particles.

The carrier structure may be configured as a section of a carrier frame, which is arranged on the measuring tube and carries the oscillation element or the respective oscillation element or the oscillation elements, at least one coupling section being formed by the carrier frame, the carrier frame being separated from the oscillation element or the oscillation elements and/or from the side wall, into which the conducted wave is to be coupled, of the measuring tube except for the coupling section. Preferably, the carrier frame forms a plurality of coupling sections. The coupling section or the coupling sections may form the respective carrier structure. The separation of the other sections from the side wall or the oscillation elements or the oscillation elements may be sufficiently large that even a respective viscous layer, if one is present, is not contacted. In particular, the coupling sections bear on the oscillation element, or the side wall, in the contact region. The use of such a carrier frame allows simple and robust construction of the measuring device. The carrier frame may, for example, be produced from plastic. Production may be carried out by milling, laser cutting, stamping, injection molding or the like.

The carrier frame may comprise at least one latch element in order to latch the oscillation element or the respective oscillation element or the oscillation elements on the carrier frame. For example, latching lugs may engage from two or more sides on the oscillation element or elements.

The carrier frame may in addition or as an alternative comprise at least one projection which engages in a recess of the measuring tube or vice versa. This may be used in order to fix the position of the carrier frame on the measuring tube, and in particular also the position of the oscillation element or of the oscillation elements relative to the measuring tube. In order to fasten the carrier frame on the measuring tube, recesses in which a respective projection engages, in particular latches, may for example be provided on two opposite sections of the measuring tube side wall, or two opposite side walls of the measuring tube.

The carrier structure and/or the projections and/or the recess of the measuring tube may have an extent perpendicularly to the side wall, into which the conducted wave is to be coupled, of the measuring tube which is at most half as great as the wavelength of that wave in the material of the carrier structure or of the side wall which has the same frequency as the conducted wave. If the extent is half as great as the wavelength, narrowband resonant coupling-in of the oscillation takes place, whereby a high efficiency of the coupling-in can be achieved. As an alternative, it is possible to use relatively small extents so that nonresonant oscillation transmission takes place. For example, the extent may be less than the wavelength by a factor of 3, 5 or 10.

The length of the carrier structure and/or of the projections and/or of the recess in the propagation direction of the conducted wave may preferably be between one half and one eighth of the wavelength of the conducted wave. It is, however, also possible for the length in the propagation direction to be approximately equally as large as the wavelength of the conducted wavelength. In this case, distances of the contact regions which are much greater than the wavelength of the conducted wave, i.e. for example 2 times as great or 2.25 times as great, may advantageously be selected.

Besides the ultrasonic meter according to the invention, the invention relates to a method for determining a fluid variable relating to a fluid and/or a fluid flow of the fluid with a measuring device which comprises a control device, a measuring tube which receives the fluid and/or through which the fluid can flow, and a first and a second ultrasound transducer which are arranged at a distance from one another on the measuring tube, wherein the first and/or the second ultrasound transducer are driven by the control device in order to excite a wave which is conducted through a side wall of the measuring tube, wherein the conducted wave excites compression oscillations of the fluid, which oscillations are conducted via the fluid to the respective other ultrasound transducer and are recorded there by the control device in order to determine measurement data, wherein the fluid variable is determined by the control device as a function of the measurement data, wherein the first and/or the second ultrasound transducer respectively comprise an oscillation element, by which oscillations are coupled, in particular only, via a plurality of mutually separated contact regions of the oscillation element into the measuring tube or into a carrier structure arranged between the measuring tube and the oscillation element, or wherein the first and/or the second ultrasound transducer respectively comprise a plurality of oscillation elements, by which oscillations are coupled, in particular only, into mutually separated contact regions of the measuring tube, or of a carrier structure coupled to the measuring tube.

The method according to the invention may be refined with those features that have been explained in relation to the measuring device according to the invention, with the advantages mentioned there.

Other features which are considered as characteristic for the invention are set forth in the appended claims.

Although the invention is illustrated and described herein as embodied in a measuring device and a method for determining a fluid variable, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic side view of a measuring device according to the invention;

FIG. 2 is a first variant of an exemplary embodiment of the ultrasound transducer in a first perspective;

FIG. 3 is a second variant of an exemplary embodiment of the ultrasound transducer in a different perspective;

FIGS. 4-6 show detail views of various further exemplary embodiments of the measuring device according to the invention;

FIG. 7 is a perspective view of a further exemplary embodiment; and

FIGS. 8-9 are views, similar to the illustration of FIG. 2, of further exemplary embodiments of the invention.

### DETAILED DESCRIPTION OF THE INVENTION

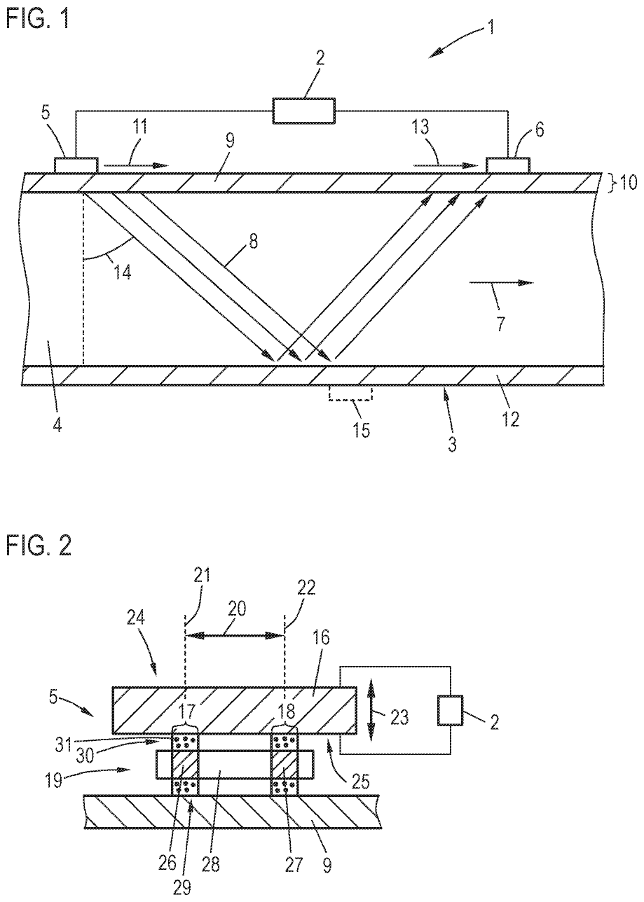

Referring now to the figures of the drawing in detail and first, particularly, to FIG. 1 thereof, there is shown a measuring device 1 for determining a fluid variable relating to a fluid and/or a fluid flow. The fluid is in this case conveyed in a direction shown by the arrow 7 through an internal space 4 of a measuring tube 3. In order to determine the fluid variable, in particular a flow volume, a time-of-flight difference between the times of flight from a first ultrasound transducer 5 to a second ultrasound transducer 6, and vice versa, may be determined by the control device 2. In this case, use is made of the fact that this time of flight depends on a velocity component of the fluid parallel to a propagation direction of an ultrasound beam 8 through the fluid. From this time of flight, it is therefore possible to determine a flow rate, averaged over the path of the respective ultrasound beam 8, in the direction of the respective ultrasound beam 8, and therefore approximately an averaged flow rate in the volume through which the ultrasound beam 8 passes.

In order on the one hand to make it possible to arrange the ultrasound transducers 5, 6 outside the measuring tube 3, and on the other hand in order to reduce a sensitivity in relation to different flow rates at different positions of the flow profile, an ultrasound beam 8, i.e. a pressure wave, is not induced directly in the fluid by the first ultrasound transducer 5. Instead, a conducted wave is excited in the side wall 9 of the measuring tube 3 by the ultrasound transducer 5. The excitation is carried out with a frequency which is selected in such a way that a Lamb wave is excited in the side wall 9. Such waves may be excited when the thickness 10 of the side wall 9 is comparable to the wavelength of the transverse wave in the solid, which is given by the ratio of the speed of sound of the transverse wave in the solid and the excited frequency.

The conducted wave excited in the side wall 9 by the ultrasound transducer 5 is represented schematically by the arrow 11. Compression oscillations of the fluid are excited by the conducted wave, and these are emitted into the fluid in the entire propagation path of the conducted wave. This is represented schematically by the ultrasound beams 8 offset relative to one another in the flow direction. The emitted ultrasound beams 8 are reflected at the opposite side wall 12 and conducted via the fluid back to the side wall 9. There, the incident ultrasound beams 8 again excite a conducted wave in the side wall 9, which is represented schematically by the arrow 13 and which can be recorded by the ultrasound transducer 6 in order to determine the time of flight. As an alternative or in addition, it is possible to record the emitted ultrasound waves by means of an ultrasound transducer 15 which is arranged on the side wall 12. In the example shown, the ultrasound beams 8 are not reflected, or are reflected only once at the side walls 9, 12, on their way to the ultrasound transducers 6, 15. It would of course be possible to use a longer measurement path, the ultrasound beams 8 being reflected several times at the side walls 9, 12.

In the described procedure, it may be problematic that the dispersion relation for Lamb waves in the side wall 9 comprises a plurality of branches. During excitation with a determined frequency predetermined by the control device 2, it would therefore be possible for different oscillation modes for the Lamb wave to be excited, which have different phase velocities. The effect of this is that the compression waves are emitted at different Rayleigh angles 14 as a function of these phase velocities. This results in different paths, which typically have different times of flight, for the conduction of the ultrasound wave from the ultrasound transducer 5 to the ultrasound transducer 6, and vice versa. The received signals for these various propagation paths would therefore need to be separated by elaborate signal processing by the control device 2 in order to be able to determine the fluid variable. This on the one hand requires an elaborate control device, and on the other hand is not robustly possible in all application cases. Maximally pure-mode excitation of conducted waves should therefore take place in the ultrasound transducer 5. Various possibilities for carrying this out with relatively low technical outlay are described below for various exemplary configurations of the ultrasound transducer 5.

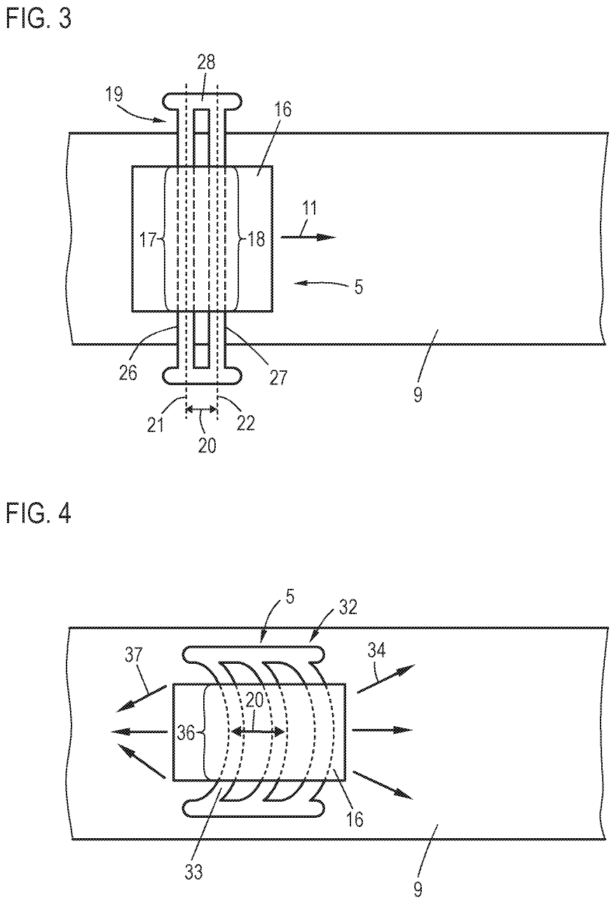

FIGS. 2 and 3 show a first embodiment variant of the ultrasound transducer 5 in two different perspectives. The ultrasound transducer comprises a piezoelectric oscillation elemental 16, which is preferably formed as a cuboid block of piezoceramic that is contacted by means of electrodes (not shown). In order to achieve pure-mode excitation, a particular wavelength should be imposed on the conducted wave by the connection of this oscillation elemental 16 to the side wall 9. This is achieved in that the oscillation elemental 16 is coupled to the side wall 9 via a carrier structure 19, the oscillation elemental 16 being coupled to the carrier structure 19 only in two mutually separated contact regions 17, 18. The coupling between the carrier structure 19 and the oscillation elemental 16, or the wall 9, is respectively carried out via a viscous layer 29, 30. This layer may, for example, consist of a silicone oil. Particles 31, in particular metal particles, may be provided in the layer in order to adapt the viscosity of the layer. When metal particles or other conductive particles 31 are used, these particles 31 may also be used to produce a certain conductivity of the viscous layers 29, 30. This may be advantageous since an electrode on the side 25 of the oscillation elemental 16 facing toward the measuring tube is often difficult to access, and for example contacting of this electrode may therefore be carried out via the viscous layer 30. An effect of oscillation coupling via the viscous layers 29, 30 is that shear forces are not transmitted, or transmitted only to a small extent, by these couplings. This is advantageous in particular when, for example in the event of temperature changes, different expansions of the oscillation elemental 16 and of the side wall 9 occur, whereby for example stresses could occur in an adhesive bond, which could damage this adhesive bond in the long term.

The construction of the carrier structure 19 may be seen well particularly in FIG. 3. Those regions of the carrier structure 19 which lie below the oscillation elemental 16 in the view shown, i.e. the contact regions 17, 18, are shown by dashes. The carrier structure 19 comprises two mutually separated ribs 26, 27, which are connected to one another by connecting sections 28. The oscillation elemental 16 bears only on the ribs 26, 27. By means of a corresponding selection of the distances of the ribs 26, 27 and therefore the centers 21, 22 of the contact regions 17, 18 in the propagation direction of the conducted wave, represented by the arrow 11, a defined wavelength may be imposed on the conducted wave.

The excitation of the conducted wave may be carried out in such a way that an expansion or compression oscillation of the oscillation elemental 16 is excited, which is represented schematically by the double arrow 23 in FIG. 2. To this end, electrodes on the side 25 facing toward the measuring tube, and on the side 24 facing away from the measuring tube, of the oscillation elemental 16 may have a time-variable potential difference applied to them by the control device 2, an expansion or a compression of the oscillation elemental 16 taking place in the height direction in FIG. 2 as a function of the potential difference. This oscillation perpendicular to the side wall is coupled into the side wall 9 only in the region of the ribs 26, 27 because of the use of the carrier structure 19. In this case, it is initially assumed below that the ribs 26, 27 are substantially constructed identically and are coupled to the oscillation elemental 16 and the side wall 9 so that inphase excitation of conducted waves respectively takes place in the region of the ribs 26, 27.

The two conducted waves induced in the region of the ribs 26, 27 are superposed in the side wall 9. If the distance 20 between the centers 21, 22 of the contact regions 17, 18 is then selected in such a way that it corresponds to the wavelength of a particular desired mode of the conducted wave in the side wall 9, or an integer multiple thereof, the conducted waves of this mode interfere constructively. Modes with wavelengths which are not integer divisors of this distance 20 are coupled into the side wall 9 not with constructive interference and therefore with a much lower amplitude. By means of a carrier structure tuned to the wavelength of the desired mode, excitation of undesired modes may therefore be substantially suppressed.

The frequency of the conducted wave to be excited may in principle be predetermined freely by corresponding driving by the control device 2. In order to achieve efficient excitation, however, a conducted wave with a frequency which is equal to a resonant frequency of the oscillation elemental 16 is preferably excited. Preferably, a conducted wave with a rigidly predetermined frequency and a rigidly predetermined wavelength should always be excited in the measuring device 1. Correspondingly, the oscillation elemental 16 may be configured or selected in such a way that its resonant frequency corresponds to this oscillation frequency, whereby the corresponding conducted wave can be excited with high efficiency. As explained above, the wavelength is predetermined by means of the layout of the carrier structure, or by means of the selection of the distance 20 between the centers 21, 22 of the contact regions 17, 18. A relationship of the distance 20 and an advantageous resonant frequency of the oscillation elemental 16 is therefore given by the dispersion relation of the side wall 9 for the conducted wave.

The length of the contact regions 17, 18 in the propagation direction of the conducted wave, shown by the arrow 11, i.e. the width of the ribs 26, 27, may be between one eighth and one half of the wavelength of the conducted wave to be excited. It is also possible for the length of the contact regions 17, 18 to be approximately as large as the wavelength of the conducted wave to be excited, the distance 20 between the centers 21, 22 in this case preferably being at least two times as great as the wavelength.

In the exemplary embodiment shown, only two contact regions 17, 18 are used. In order to further improve the mode purity, in one exemplary embodiment (not shown) further contact regions 17, 18 may be used.

The measuring tube 3 may be composed of a plurality of substantially straight side walls. It is, however, also possible to use the described procedure in substantially round measuring tubes, in which case a side surface on which the ultrasound transducers 5, 6 are arranged may be flattened at least on the outer surface side. As an alternative, the outer side may also be curved and the side of the ultrasound transducer 5, 6 facing toward the measuring tube 3 may bear on this curved surface. For example, a round measuring tube 3 may be used.

In the exemplary embodiment shown, the carrier structure 19 protrudes beyond this side wall 9. As an alternative, it would also be possible to use a carrier structure which is shorter in the height direction in FIG. 3, which bears fully on the side wall 9 or at least does not extend beyond the region of the side wall 9.

In the explanation above of the superposition of the conducted waves coupled in it was initially assumed that inphase excitation of conducted waves in the side wall 9 takes place via the two ribs 26, 27. It is, however, also possible to adapt the carrier structure 19, or the coupling between the carrier structure 19 and the oscillation elemental 16 or the side wall 9, in such a way that a particular phase offset is deliberately produced. For example, the thickness of the ribs 26, 27 perpendicular to the side wall 9 may be adapted and/or the ribs 26, 27 may be formed from different material, so that the time of flight of the oscillation coupled in is different for the two ribs 26, 27. If a structure is now selected with which the excitation in the region of the first and second ribs 26, 27 takes place with a phase offset of 90°, and if the distance 20 between the ribs 26, 27 is selected in such a way that it is the sum of an integer multiple of the wavelength and one fourth of the wavelength of the conducted wave to be generated, superposition of the two conducted waves coupled in takes place in such a way that the component of the conducted wave traveling toward the left in FIGS. 1 to 3 is canceled out and only the component traveling toward the right remains, or vice versa. Direction-selective excitation of conducted waves may therefore be carried out, which may be expedient in order to avoid undesired multipath propagation and furthermore to increase the efficiency of the coupling-in for the desired propagation path.

FIG. 4 shows an alternative construction for the ultrasound transducer 5, which differs from the construction shown in FIGS. 2 and 3 with regard to the carrier structure 32. The carrier structure 32 in this case comprises three ribs 33, which contact the oscillation elemental 16, or the measuring tube 9, in a respective contact region 36. The distances 20 between the centers of these contact regions 36 are again integer multiples of the wavelength of the conducted wave to be excited. In contrast to the exemplary embodiments above, however, the ribs 33 are curved. The effect of this is that the propagation direction of the conducted wave is locally different along the ribs 33. As is represented by the arrows 34, 37, this results in the emission of the conducted wave in a widening angle range in one emission direction and focusing of the conducted wave in the other emission direction.

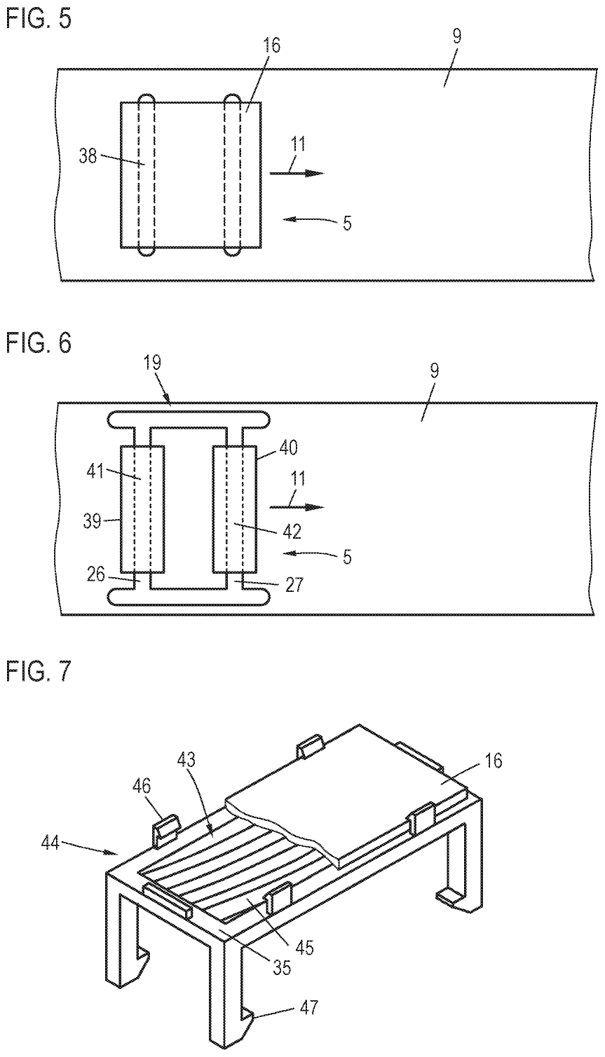

FIG. 5 shows another possibility for the construction of the ultrasound transducer 5. In contrast to the exemplary embodiments above, the carrier structure in this exemplary embodiment is formed from separate components 38, which are not connected by connecting sections. Although use of connecting sections facilitates the arrangement of the individual components on the measuring tube, these connecting sections are however not required for the function described.

FIG. 6 represents another alternative construction of the ultrasound transducer 5. The construction in this case corresponds substantially to the construction shown in FIGS. 2 and 3, separate oscillation elements 39, 40 being used instead of a common oscillation elemental 16 which bears on the two ribs 26, 27 of the carrier structure 19. The ultrasound transducer 5 therefore comprises a plurality of piezoelectric oscillation elements 39, 40, which are coupled to the measuring tube 3 or the side wall 9 in mutually separated contact regions 41, 42. The two oscillation elements 39, 40 may be driven together by the control device 2. Preferably, the two electrodes facing away from the measuring tube, and/or the two electrodes facing toward the measuring tube, of the oscillation elements 39, 40 are respectively connected to one another. Phase-synchronous excitation of the oscillation elements 39, 40 may therefore be carried out.

FIG. 7 shows a possible way of fastening the ultrasound transducer 5 robustly on the measuring tube. In this case, a carrier frame 44 is used, which forms the carrier structure 43 in a section of the carrier frame 44. The carrier structure is formed by coupling sections 45, which protrude beyond a frame 35 in a direction perpendicular to the side wall 9, whereby the oscillation elemental 16 and the side wall 9 are contacted only via these coupling sections. The coupling sections correspond in their shape to the ribs 33 in FIG. 4.

In order to hold the oscillation elemental 16, the carrier frame 44 comprises latching sections 46, by which the oscillation elemental 16 is latched. Holding on the tube is carried out by means of projections 47, namely latching lugs, which engage in recesses of the measuring tube.

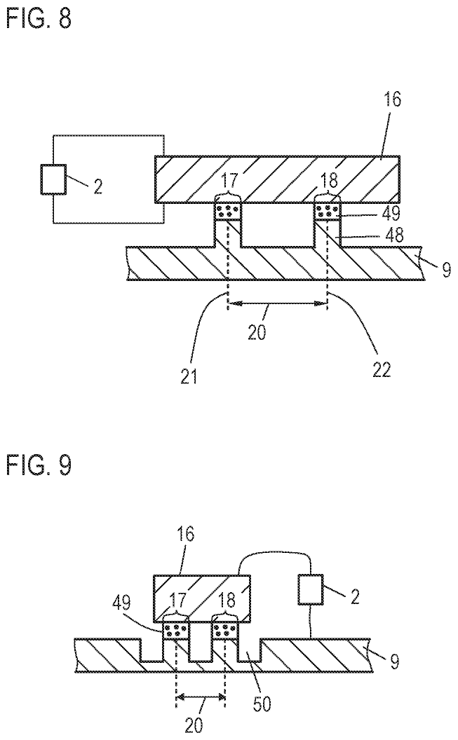

In the exemplary embodiments above, a carrier structure formed separately from the measuring tube 3 was respectively used, in order to achieve the effect that the oscillation element is coupled to the side wall 9 only via mutually separated contact regions, or excitation regions. As an alternative, however, it is possible to provide corresponding structures directly on the side wall 9. A first example thereof is represented in FIG. 8. The side wall 9 in this case comprises two projections 48, which are coupled to the oscillation element 16 via a respective viscous layer 49. In this way, exactly as explained with reference to FIGS. 2 and 3, two contact regions 17, 18 are formed, in which case mode-selective excitation may be achieved by selection of a corresponding distance 20 between the centers 21, 22 into these contact regions 17, 18, as already explained.

A corresponding contact structure for forming the contact regions 17, 18 may also be produced by introducing recesses 50 into the side wall 9 of the measuring tube 3. This is represented in FIG. 9. FIG. 9 furthermore shows contacting of the oscillation elemental 16 by the side wall 9 and the conductive viscous layer 49.

The following is a list of reference numerals used in the above description of the invention:

1 measuring device

2 control device

3 measuring tube

4 internal space

5 ultrasound transducer

6 ultrasound transducer

7 arrow

8 ultrasound beam

9 side wall

10 thickness

11 arrow

12 side wall

13 arrow

14 Rayleigh angle

15 ultrasound transducer

16 oscillation element

17 contact region

18 contact region

19 carrier structure

20 distance

21 center

22 center

23 double arrow

24 side facing away from the measuring tube

25 side facing toward the measuring tube

26 rib

27 rib

28 connecting section

29 layer

30 layer

31 particle

32 carrier structure

33 rib

34 arrow

35 frame

36 contact region

37 arrow

38 component

39 oscillation element

40 oscillation element

41 contact region

42 contact region

43 carrier structure

44 carrier frame

45 coupling section

46 latch element

47 projection

48 projection

49 viscous layer

50 recess

1. A measuring device for determining a fluid variable relating to a fluid and/or a fluid flow of the fluid, the measuring device comprising:
a control device;
a measuring tube for containing the fluid or the fluid flow;
first and second ultrasound transducers disposed on said measuring tube at a spacing distance from one another, with one or both of said ultrasound transducers being configured to be driven by said control device in order to excite a wave that is conducted through a side wall of said measuring tube, wherein the conducted wave excites compression oscillations of the fluid that are conducted via the fluid to the respectively other ultrasound transducer and are recorded there by the control device in order to determine measurement data, and wherein the fluid variable is determined by said control device in dependence on the measurement data;
wherein either said first ultrasound transducer and/or said second ultrasound transducer respectively includes an oscillation element coupled in a plurality of mutually separated contact regions of said oscillation element to said measuring tube or to a carrier structure disposed between said measuring tube and said oscillation element; or
wherein said first ultrasound transducer and/or said second ultrasound transducer respectively include a plurality of oscillation elements coupled in mutually separated contact regions of said measuring tube, or of a carrier structure coupled to said measuring tube, to said measuring tube, or said carrier structure.

2. The measuring device according to claim 1, wherein a spacing distance between centers of at least two contact regions of said first ultrasound transducer and/or of said second ultrasound transducer in a propagation direction of the conducted wave corresponds to an integer multiple of a wavelength of the conducted wave.

3. The measuring device according to claim 1, wherein a frequency of the conducted wave is equal to a resonant frequency of said oscillation element or of said oscillation elements.

4. The measuring device according to claim 1, wherein an excitation of said measuring tube with a phase offset of 90° takes place by way of two contact regions of said first ultrasound transducer and/or of the second ultrasound transducer, the distance between the centers of the two contact regions in the propagation direction of the conducted wave being a sum of an integer multiple of the wavelength and one fourth of the wavelength of the conducted wave.

5. The measuring device according to claim 1, wherein said carrier structure comprises at least two mutually separated ribs that are connected by at least one connecting section, and wherein said oscillation element or oscillation elements bear only on said ribs.

6. The measuring device according to claim 5, wherein said ribs extend perpendicularly to the propagation direction of the conducted wave.

7. The measuring device according to claim 1, wherein said measuring tube comprises, in a region of said first ultrasound transducer and/or of said second ultrasound transducer, a contact structure being a plurality of projections and/or at least one recess, said contact regions being arranged only in a region of said projections and/or outside a region of said recess.

8. The measuring device according to claim 1, wherein said contact regions respectively have a constant length in the propagation direction of the conducted wave, and/or in that all the contact regions have an equal predetermined width perpendicularly to the excitation direction.

9. The measuring device according to claim 1, wherein said contact regions are curved.

10. The measuring device according to claim 1, which comprises a viscous layer coupling said oscillation element or said oscillation elements to said measuring tube.

11. The measuring device according to claim 1, which comprises a viscous layer coupling said carrier structure or carrier structures to said measuring tube.

12. The measuring device according to claim 1, wherein said carrier structure is a segment of a carrier frame disposed on said measuring tube and carrying said oscillation element or said oscillation elements, at least one coupling section being formed by said carrier frame, said carrier frame being separated from said oscillation element or said oscillation elements and/or from said side wall, into which the conducted wave is to be coupled, of said measuring tube except for said coupling section.

13. The measuring device according to claim 12, wherein said carrier frame is formed with at least one latch element configured for latching said oscillation element or said oscillation elements on said carrier frame.

14. The measuring device according to claim 12, wherein said carrier frame comprises at least one projection which engages in a recess of said measuring tube or vice versa.

15. The measuring device according to claim 12, wherein said carrier structure and/or said projections and/or said recess of said measuring tube has or have an extent perpendicularly to the side wall, into which the conducted wave is to be coupled, of said measuring tube which is at most half as great as a wavelength of the wave in the material of said carrier structure or of the side wall which has the same frequency as the conducted wave.

16. A method for determining a fluid variable relating to a fluid and/or a fluid flow of the fluid, the method comprising:
providing a measuring device with a control device, a measuring tube for receiving the fluid or conducting the fluid flow, and first and second ultrasound transducers disposed at a spacing distance from one another on the measuring tube;
driving one or both of the first or second ultrasound transducers by the control device to excite a wave that is conducted through a side wall of the measuring tube, whereupon a conducted wave excites compression oscillations of the fluid, and the oscillations are conducted via the fluid to the respectively other ultrasound transducer and are recorded there by the control device in order to determine measurement data;
determining the fluid variable by the control device in dependence on the measurement data;
providing the first and/or second ultrasound transducer with an oscillation element and coupling oscillations via a plurality of mutually separated contact regions of the oscillation element into the measuring tube or into a carrier structure arranged between the measuring tube and the oscillation element; or
providing the first and/or second ultrasound transducer with a plurality of oscillation elements and coupling oscillations into mutually separated contact regions of the measuring tube or of a carrier structure coupled to the measuring tube.
